(19) United States
(12) Patent Application Publication
(10) Pub. No.: US 2014/0218977 A1
(43) Pub. Date: Aug. 7, 2014

(54) SWITCHING POWER SUPPLY CIRCUIT

(71) Applicant: Funai Electric Co., Ltd., Osaka (JP)

(72) Inventors: Hitoshi MIYAMOTO, Daito-shi (JP); Takashi JINNOUCHI, Daito-shi (JP)

(73) Assignee: Funai Electric Co., Ltd., Osaka (JP)

(21) Appl. No.: 14/165,886

(22) Filed: Jan. 28, 2014

(30) Foreign Application Priority Data
Feb. 5, 2013 (JP) 2013-020834

(51) Int. Cl. H02M 3/335

(52) U.S. Cl. CPC H02M 3/33523
USPC 363/21.12

(57) ABSTRACT

A switching power supply circuit includes a switching element that switches power fed to a primary winding of a transformer and thus induces a voltage in the secondary winding, and an oscillation circuit that oscillates to generate a pulse signal to control switching action. The oscillation circuit repeatedly performs intermittent oscillation of the pulse signal, and in each of the intermittent oscillation cycles, increases or decreases the number of pulses in the pulse signal to lengthen or shorten the oscillating portion of the pulse signal, and at the time of lengthening or shortening, the oscillation circuit respectively lengthens or shortens an oscillation-halted portion, thus varying the period of the intermittent oscillation cycles.

### BACKGROUND OF THE INVENTION

1. Field of the Invention

The present invention relates to a switching power supply circuit that outputs voltage to a load.

2. Description of the Related Art

Conventionally, switching power supply circuits have been known in which a switching element is connected in series to the primary winding of a transformer, the switching action of the switching element switches the power feed to the primary winding of the transformer on and off, thereby inducing a voltage in the secondary winding of the transformer and providing smoothed output of the voltage thus induced to a load. This switching power supply circuit includes an oscillation circuit that oscillates to generate a pulse signal for controlling the switching action of the switching element and a frequency multiplier that multiplies the frequency of the output signal of this oscillation circuit. When the load is light, the oscillation circuit repeatedly performs intermittent oscillation cycles including oscillation to generate a pulse signal and the halt of oscillation, thus lowering the value of the voltage output to the load and thereby bringing the output voltage to the minimum required level. The frequency multiplier multiplies the frequency of the output signal from the oscillation circuit such that the frequency of the intermittent oscillation cycles is higher than the range of human hearing. With such a switching power supply circuit, it is possible to achieve electric power conservation through intermittent oscillation and also to make transformer hum or other noise arising from intermittent oscillation less perceptible to users. See, for example, Japanese Patent Application Laid-Open Publication No. 2010-268657.

However, with such a switching power supply circuit as described in Japanese Patent Application Laid-Open Publication No. 2010-268657, in order to make the noise in intermittent oscillation less perceptible to users, a frequency multiplier is necessary, so the manufacturing cost ends up being high.

### SUMMARY OF THE INVENTION

In view of the above-described problems, preferred embodiments of the present invention provide a switching power supply circuit that achieves power conservation, makes transformer hum or other noise less perceptible to users, and significantly reduces manufacturing costs.

A switching power supply circuit according to a preferred embodiment of the present invention includes a transformer including a primary winding that is fed power from a power source and a secondary winding, a switching element that switches the power feed to the primary winding and thus induces a voltage in the secondary winding, an oscillator arranged to oscillate to generate a pulse signal in order to control a switching action of the switching element; and a controller arranged and programmed to control the oscillator such that the oscillator repeatedly performs a plurality of intermittent oscillation cycles each including the oscillation to generate a pulse signal and halting of the oscillation, and in each of the intermittent oscillation cycles, increases or decreases the number of pulses in the pulse signal to lengthen or shorten the oscillating portion of the pulse signal, and when the oscillating portion is lengthened, a oscillation-halted portion of the pulse signal is made longer, and when the oscillating portion is shortened, the oscillation-halted portion is made shorter, so as to vary a period of the intermittent oscillation cycles.

With this configuration, the intermittent oscillation of the oscillator intermittently induces voltage in the secondary winding of the transformer, so in the case of smoothing this voltage and outputting it to a load, for example, it is possible to lower the output voltage to that load. Accordingly, when the load is light, it is possible to output to the load only the minimum required voltage which depends on the load, and this makes it possible to eliminate wasteful supply of electrical power and to achieve conservation of electric power. Furthermore, even if transformer hum or other noise is generated due to the intermittent oscillation, and the frequency of this intermittent oscillation is within the audible frequency band, it is possible to prevent bias in frequency components in the noise by varying the period of intermittent oscillation, and the noise can therefore be made less perceptible to users. Moreover, it is not necessary to provide a frequency multiplier as in the past in order to make this noise less perceptible, so the manufacturing cost can be reduced.

In a preferred embodiment of the present invention, it is preferable that the switching power supply circuit includes an output device arranged to smooth the voltage induced in the secondary winding and output smoothed voltage to the load, and that the controller cause the oscillator to vary the period of the intermittent oscillation when the voltage to be output to the load by the output device is less than a threshold value, but when the voltage to be output is greater than or equal to the threshold value, the controller causes the oscillator to make the period of the intermittent oscillation constant, thus setting the number of pulses in the pulse signal in each cycle of the intermittent oscillation to a number of pulses that depends on the voltage to be output, without increasing or decreasing the number of pulses in the pulse signal in each cycle of the intermittent oscillation.

With this configuration, if the number of pulses in the pulse signal in each cycle of intermittent oscillation is increased, for example, depending on the voltage to be output to the load when this voltage becomes greater than or equal to the threshold value, then the oscillating portion of the pulse signal becomes longer, while the oscillation-halted portion becomes shorter. Accordingly, the upper-limit value of the voltage that can be output to the load becomes higher. Even if noise is generated due to the intermittent oscillation, and the frequency of this intermittent oscillation is within the audible frequency band, with respect to the frequency components of the noise, the frequency components of the pulse signal itself become relatively more numerous than the frequency components of intermittent oscillation. Because of this, if the frequency of the pulse signal is outside the audible frequency band, the noise can be made less perceptible to users.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram showing the configuration of an electric device equipped with the switching power supply circuit according to a preferred embodiment of the present invention.

FIG. 2 is a circuit diagram showing the configuration of the switching power supply circuit.

FIG. 3 is a block diagram showing the configuration of the control IC of the switching power supply circuit.

FIG. 4 is a diagram showing a truth table for the RS flip-flop circuit within the control IC.

FIG. 5 is a signal waveform diagram showing a control signal that is output from the control IC.

FIG. 6A is a signal waveform diagram showing a control signal that is output by the control IC when the set value of the output voltage is low in the switching power supply circuit according to one modified example of a preferred embodiment of the present invention, and FIG. 6B is a signal waveform diagram showing a control signal when this set value is high.

### DETAILED DESCRIPTION OF THE PREFERRED EMBODIMENTS

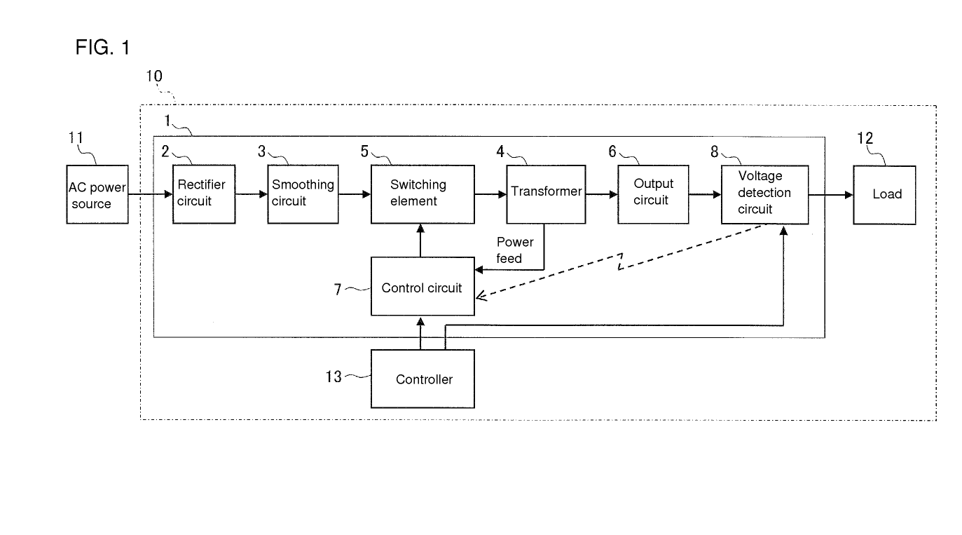

A switching power supply circuit (hereinafter, abbreviated as “power supply circuit”) according to a preferred embodiment of the present invention will be described with reference to the drawings. FIG. 1 shows the configuration of an electric device equipped with the power supply circuit of the present preferred embodiment, as well as the schematic configuration of this power supply circuit. The electric device 10 is equipped with a power supply circuit 1 that is fed power from an AC power source 11 and supplies voltage to a load 12, along with a controller 13 that is arranged and programmed to operate the load 12. A non-limiting example of a device to which this power supply circuit is applicable is a video device. The controller 13 is arranged and programmed to switch the operating mode of the load 12 between standby mode and normal mode. Furthermore, within normal mode, it is switchable among a plurality of operating modes depending on the plurality of operations of the load 12. The load 12 requires different voltages depending on the operating mode set by the controller 13. For this reason, the power supply circuit 1 supplies the load 12 with the voltage required by the load 12 depending on the operating mode of the load 12 set by the controller 13. For example, when the load 12 is set to standby mode, the power supply circuit 1 supplies the load 12 with a standby voltage which is the minimum level required by the load 12 in this standby mode. In the following, for convenience of explanation, the voltage required by the load 12 in the operating mode set by the controller 13, i.e., the value of the voltage to be output by the power supply circuit 1 to the load 12, is called the “set voltage” or “voltage set” by the controller.

The power supply circuit 1 includes a transformer 4 that is fed power to its primary side from the AC power source via a rectifier circuit 2 and a smoothing circuit 3, a switching element 5 that switches the power feed to the primary side of the transformer 4, and an output circuit 6 that outputs to the load 12 the voltage induced on the secondary side of the transformer 4 due to this switching action. Moreover, the power supply circuit 1 includes a control circuit 7 which controls the switching action of the switching element 5 and a voltage detection circuit 8 which detects the difference in potential between the voltage set by the controller 13 and the voltage output by the output circuit 6.

The control circuit 7 controls the switching action of the switching element 5 such that the voltage output by the output circuit 6 is equal to or greater than the voltage set by the controller 13. In addition, the control circuit 7 drives, as a power source, the voltage induced on the ternary side of the transformer 4 due to the switching action of the switching element 5. The voltage detection circuit 8 sends a detection signal indicating the difference in potential that is detected to the control circuit 7 by optical communications. The control circuit 7 receives this detection signal and controls the switching action of the switching element 5 based on this detection signal.

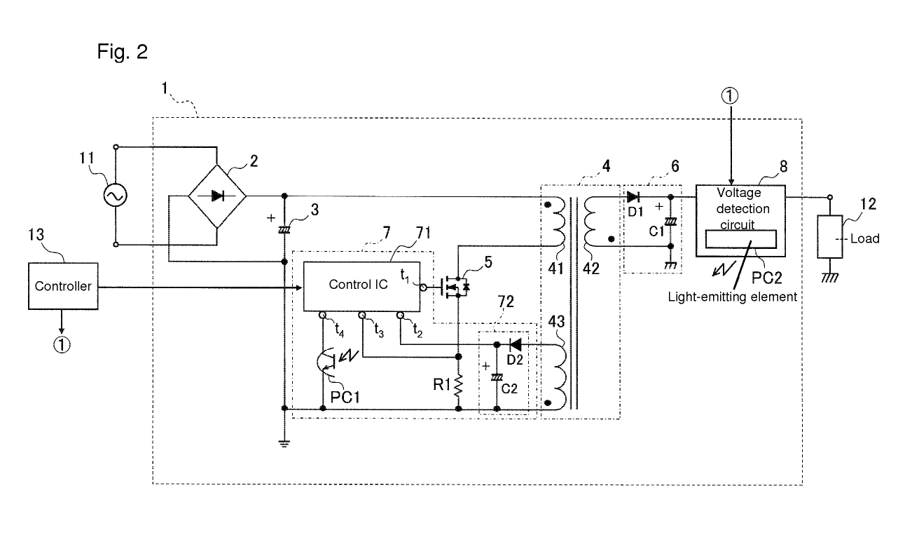

FIG. 2 shows the detailed configuration of the power supply circuit 1. The rectifier circuit 2 preferably includes, for example, a diode bridge circuit that performs full-wave rectification of the AC voltage supplied from the AC power source 11. The smoothing circuit 3 preferably includes, for example, a capacitor that smoothes the pulsating voltage after full-wave rectification by the rectifier circuit 2, and supplies the DC voltage after this smoothing to the transformer 4.

The transformer 4 includes a primary winding 41 that is supplied with the voltage after smoothing by the smoothing circuit 3, a secondary winding 42, and a ternary winding 43. The power fed to the primary winding 41 is switched by the switching element 5, so as to induce voltage in the secondary winding 42 and ternary winding 43. The transformer 4 preferably includes a flyback transformer, and the voltages induced upon the secondary winding 42 and ternary winding 43, respectively, are flyback voltages.

The switching element 5 preferably is a power MOSFET or the like. This power MOSFET is connected in series with the primary winding 41, or more specifically, its drain is connected to the primary winding 41, its source is grounded via a resistor R1 (to be described later), and its gate is connected to the control circuit 7. The power MOSFET switches between the ON state and the OFF state depending on the value of a control signal that is output to the gate from the control circuit 7, so as to turn the current flowing through the primary winding 41 ON or OFF and switch the power feed to the primary winding 41. The control signal is a signal that controls the switching action of the switching element 5 and includes a pulse train. The power MOSFET turns ON the power feed to the primary winding 41 when the value of the control signal is High, and turns OFF the power feed to the primary winding 41 when the value of the control signal is Low. As was described above, the transformer 4 preferably includes a flyback transformer, so when the power feed to the primary winding 41 is turned ON, energy is stored in the transformer 4, but when the power feed to the primary winding 41 is turned OFF, the stored energy is released from the transformer 4, thus inducing a voltage in the secondary winding 42.

The output circuit 6 (output device) includes a diode D1 that rectifies the voltage induced in the secondary winding 42 and a capacitor Cl that smoothes this rectified voltage, so that the output circuit 6 outputs to the load 12 the DC voltage after smoothing by the capacitor Cl.

The control circuit 7 includes a control IC 71 that generates the control signals and a voltage adjusting circuit 72 that converts the voltage induced in the ternary winding 43 to a voltage suitable for driving the control IC 71 and supplies this voltage to the control IC 71.

The control IC 71 includes terminals t₁, t₂, t₃, and t₄. The terminal t₁ is connected to the switching element 5, and the control IC 71 outputs control signals to the switching element 5 via the terminal t₁. The terminal t₂ is connected to the voltage adjusting circuit 72, and the control IC 71 is fed power from the voltage adjusting circuit 72 via the terminal t₂. The voltage to ground of the resistor R1 connected in series to the primary winding 41 and the switching element 5 is applied to the terminal t₃. This voltage to ground fluctuates depending on the value of the current flowing in the primary winding 41. For this reason, after setting the value of the control signal to High, the control IC 71 determines, based on the voltage to ground applied to the terminal t₃, whether or not sufficient energy has been accumulated in the transformer 4 after the power feed to the primary winding 41 was turned ON, and when this voltage to ground becomes equal to or greater than a stipulated value, the value of the control signal is set to Low, thus turning OFF the power feed to the primary winding 41. The terminal t₄ is connected to a light-receiving element PC1 that receives the detection signals from the voltage detection circuit 8. Based on the detection signals received by the light-receiving element PC1, the control IC 71 controls the switching action of the switching element 5 using control signals so as to reduce the potential difference between the voltage set by the controller 13 and the output voltage from the output circuit 6.

The voltage adjusting circuit 72 includes a diode D2 that rectifies the voltage induced by the ternary winding 43 and a capacitor C2 that smoothes this rectified voltage, and the voltage adjusting circuit 72 supplies the DC voltage after smoothing by the capacitor C2 to the control IC 71.

The voltage detection circuit 8 includes a light-emitting element PC2 that emits the detection signals for the light-receiving element PC1. The light-receiving element PC1 and the light-emitting element PC2 constitute a photocoupler.

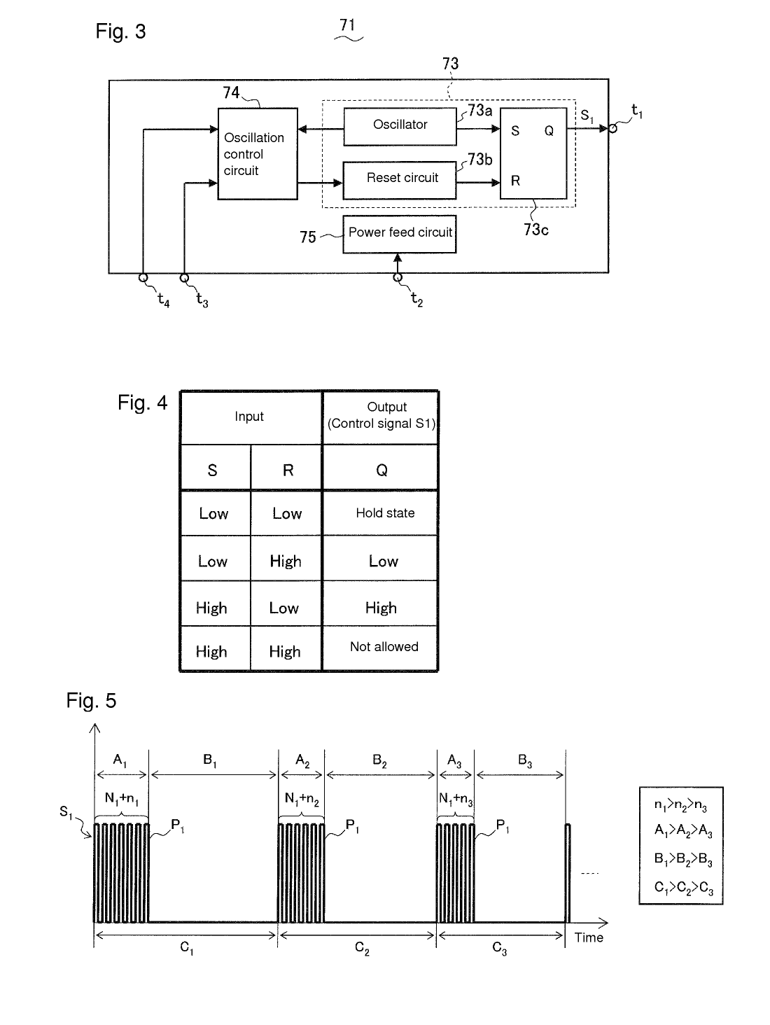

FIG. 3 shows the configuration of the control IC 71. The control IC 71 includes an oscillation circuit 73 (oscillator), an oscillation control circuit 74 (controller) that controls the oscillation operations of the oscillation circuit 73, and a power feed circuit 75 that feeds power to the various circuits within the control IC 71 using the voltage supplied by the voltage adjusting circuit 72 as its power source.

The oscillation circuit 73 includes an oscillator 73a that oscillates to generate a pulse signal including a pulse train with a constant frequency, a reset circuit 73b that outputs a reset signal, and an RS flip-flop (hereinafter referred to as “RS-FF”) circuit 73c that generates a control signal based on the pulse signal generated by the oscillation of the oscillator 73a and the reset signal output by the reset circuit 73b.

The frequency of the pulse signal generated by the oscillation of the oscillator 73a preferably is about 20 kHz to 150 kHz, for example. The RS-FF circuit 73c is preferably configured in the same manner as a general-purpose RS-FF circuit and includes an S terminal, an R terminal, and a Q terminal. The pulse signal is input to the S terminal, the reset signal is input to the R terminal, and the control signal is output from the Q terminal.

The process of controlling the oscillation of the oscillation circuit 73 by the oscillation control circuit 74 will be described with reference to FIG. 4 and FIG. 5. FIG. 4 shows a truth table for the RS-FF circuit 73c. FIG. 5 shows the control signal S₁ output from the RS-FF circuit 73c.

First, the fundamental process of controlling oscillation will be described. In a state in which the oscillation control circuit 74 causes the reset circuit 73b to make the value of the reset signal Low, when the value of the pulse signal generated by oscillation of the oscillator 73a becomes High, the RS-FF circuit 73c sets the value of the control signal S₁ to High. This turns ON the switching element 5, the power feed to the primary winding 41 turns ON, and the voltage to ground of the resistor R1 becomes higher. When the voltage to ground of the resistor R1 reaches a reference voltage (at this point, the value of the pulse signal generated by oscillation of the oscillator 73a is switched to Low), the oscillation control circuit 74 causes the reset circuit 73b to make the value of the reset signal High. This causes the RS-FF circuit 73c to set the value of the control signal S₁ to Low. As a result, the switching element 5 is turned OFF, the power feed to the primary winding 41 is turned OFF, and the voltage to ground of the resistor R1 becomes lower. When this voltage to ground drops below the reference voltage, the oscillation control circuit 74 causes the reset circuit 73b to make the value of the reset signal Low. Thereafter, when the pulse signal rises and its value becomes High, the process is repeated, and the pulse signal P₁ is generated as the control signal S₁ from the oscillation circuit 73.

Next, the process of controlling oscillation characteristic of the present preferred embodiment will be described. Through this process of controlling oscillation, in each cycle of intermittent oscillation, the oscillation circuit 73 regularly increases or decreases the number of pulses in the pulse signal P₁, thus lengthening or shortening the oscillating portion of the pulse signal P₁, and when the oscillating portion is lengthened, the oscillation-halted portion of the pulse signal P₁ is made longer, whereas when the oscillating portion is shortened, the oscillation-halted portion is made shorter, so as to vary the period of the intermittent oscillation cycles.

The specific operations of the oscillation control circuit 74 in this process of controlling oscillation will be described. It is assumed that the output voltage of the output circuit rises, and the potential difference between this output voltage and the voltage set by the controller 13 becomes less than a specified value. When this state is detected based on the detection signal from the voltage detection circuit 8, the oscillation control circuit 74 forcibly sets the value of the reset signal of the reset circuit 73b to High at a timing shifted by n pulses from the timing of this detection, at the timing at which the value of the pulse signal generated by oscillation of the oscillator 73a becomes Low. Consequently, the RS-FF circuit 73c sets the value of the control signal S₁ to Low, thus halting the oscillation of the pulse signal P₁ as the control signal S₁.

It is assumed that the output voltage decreases thereafter, and the potential difference between this output voltage and the set voltage becomes the specified value or greater. When this state is detected based on the detection signal from the voltage detection circuit 8, the oscillation control circuit 74 sets the value of the reset signal of the reset circuit 73b to Low. In this case, the next pulse signal is generated by oscillation of the oscillator 73a, and if its value becomes High, the RS-FF circuit 73c sets the value of the control signal S₁ to High. Then, based on the pulse signal generated by oscillation of the oscillator 73a, the RS-FF circuit 73c outputs the pulse signal P₁ as the control signal S₁ as described above. As a result, the oscillation of the pulse signal P₁ is resumed. In each cycle of such intermittent oscillation made up of oscillation and a halt of oscillation, the number of pulses n increases or decreases.

Here, N₁ is designated, for example, to be the base number of pulses in three cycles of intermittent oscillation shown in FIG. 5 described above. This base number of pulses N₁ is the minimum number of pulses required to increase the output voltage and bring the potential difference between the output voltage and the set voltage to less than the specified value. In addition, the numbers of additional pulses n added to the base number of pulses N₁ in these cycles of intermittent oscillation (hereinafter referred to as the “number of additional pulses”) are respectively designated as n₁, n₂, and n₃. Furthermore, within these cycles of intermittent oscillation, let A₁, A₂, and A₃ be the oscillating portions, B₁, B₂, and B₃ be the oscillation-halted portions, and C₁, C₂, and C₃ are the time periods required for each cycle of intermittent oscillation.

The numbers of additional pulses n₁, n₂, and n₃ decrease by one pulse each in this order, and thus the oscillating portions A₁, A₂, and A₃ become one period of the pulse signal shorter in this order. Accordingly, following each cycle of intermittent oscillation, the time period of the power feed to the primary winding 41 becomes shorter, and thus the charging time of the capacitor C2 within the output circuit 6 from this power feed is shortened. This therefore reduces the time periods after the end of each of the oscillating portions A₁, A₂, and A₃ and until the potential difference between the output voltage and the set voltage is widened to the specified value or greater due to the decrease in the output voltage. As a result, the time period until the voltage detection circuit 8 detects that this potential difference has become equal to or greater than the specified value becomes shorter, hastening the resumption of oscillation, and thus the oscillation-halted portions B₁, B₂, and B₃ get successively shorter in this order. Accompanying this, the time periods required for the three cycles of intermittent oscillation C₁, C₂, and C₃ get successively shorter in this order.

Only a portion of the oscillation operation is shown in the FIG. 5. In each cycle of intermittent oscillation, the oscillation circuit 73 may increase the number of pulses in the pulse signal from the base number of pulses N₁ by one pulse each, for example, and after this added number reaches a preset upper-limit value, may decrease the number of pulses by one pulse each, for example, as shown in the FIG. 5 until the number of pulses is equal to the base number of pulses N₁. The oscillation circuit 73 repeats such increase and decrease in the number of pulses. Accordingly, the number of pulses are different between successive cycles of intermittent oscillation (for example, between the m^{th} cycle of intermittent oscillation and the (m+1)^{th} cycle of intermittent oscillation).

In the present preferred embodiment, a voltage is intermittently induced in the secondary winding 42 of the transformer 4 due to the intermittent oscillation of the oscillation circuit 73, and this voltage is smoothed and output to the load 12, so the output voltage to the load 12 is lowered. Accordingly, when the load 12 is light, it is possible to output to the load 12 only the minimum voltage necessary which depends on the load 12, and this makes it possible to eliminate the wasteful supply of power and to achieve electric power conservation. Moreover, even if noise such as hum of the transformer 4 is generated due to the intermittent oscillation, and the frequency of this intermittent oscillation is within the audible frequency band, it is possible to prevent bias in frequency components in the noise by varying the period of intermittent oscillation, and noise is therefore made less perceptible to users. In addition, there is no need to provide a frequency multiplier as in the past in order to make the noise less perceptible, so the manufacturing cost can be reduced.

Next, the power supply circuit according to one modified example of a preferred embodiment will be described. With regard to the various circuits included in the power supply circuit of this modified example, the configurations are preferably the same as in the above-described preferred embodiment, so a description will be given while referring to FIGS. 2 and 3 again with the same symbols being assigned. Furthermore, only the points of difference from the above-described preferred embodiment will be described.

In the power supply circuit 1 of this modified example, the process of controlling the oscillation of the oscillation circuit 73 by the oscillation control circuit 74 is different depending on whether the voltage set by the controller 13 is a standby voltage that is less than a threshold value or a normal voltage that is equal to or greater than the threshold value. The normal voltage is defined to be that set by the controller 13 when the load 12 is set to one of a plurality of operating modes as normal mode, indicating the value of the voltage required by the load 12 in that operating mode. If the set voltage is the standby voltage, the oscillation control circuit varies the period of intermittent oscillation of the oscillation circuit 73 in the same manner as in the preferred embodiment (see FIG. 5).

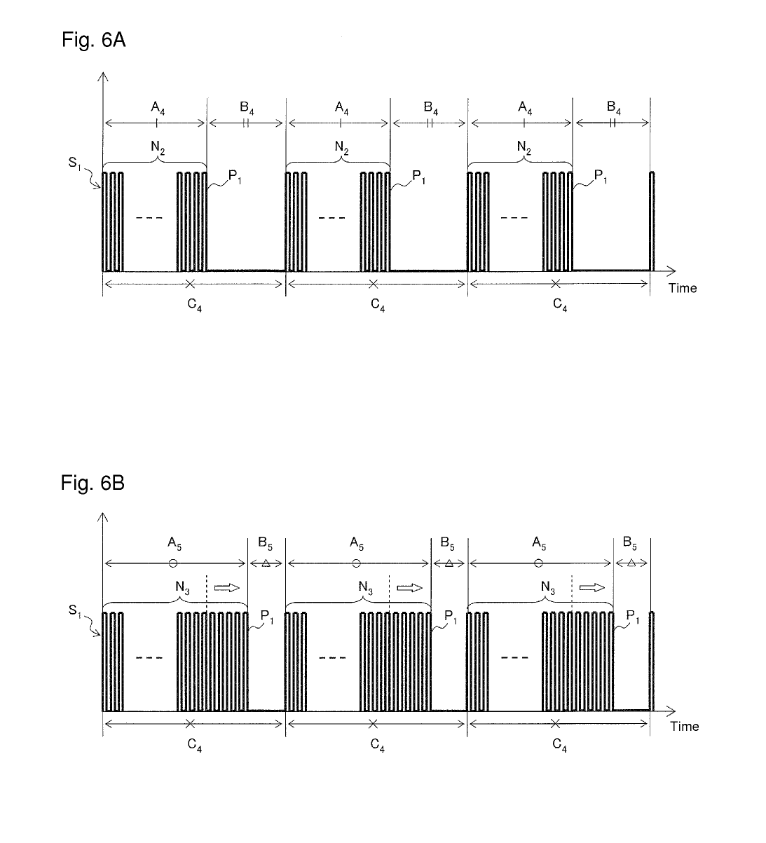

On the other hand, if the set voltage is the normal voltage, the oscillation control circuit 74 causes the oscillation circuit 73 to oscillate as shown in FIGS. 6A and 6B, in a manner different from that of the preferred embodiment. FIGS. 6A and 6B show the control signal S₁ output from the oscillation circuit 73 when the set voltage is a low normal voltage and when the set voltage is a high normal voltage, respectively. When the set voltage is a normal voltage, the oscillation control circuit 74 causes the oscillation circuit 73 to make the period of intermittent oscillation a constant time period C₄. Moreover, rather than increasing or decreasing the number of pulses in the pulse signal as the control signal S₁ in each cycle of intermittent oscillation, the oscillation control circuit 74 causes the oscillation circuit 73 to make the number of pulses in the pulse signal in each cycle of intermittent oscillation (hereinafter, shortened to the “number of pulses in each cycle”) constant at a number of pulses depending on the set voltage. Accordingly, the oscillating portion of each cycle becomes constant at a time period that is contingent on the set voltage, and accompanying this, the oscillation-halted portion of each cycle also becomes the same.

The number of pulses in each cycle becomes greater in proportion to the set voltage. If the set voltage is low (see FIG. 6A), the number of pulses in each cycle becomes a small number of pulses N₂. Accordingly, the oscillating portion A₄ becomes shorter, and the oscillation-halted portion B₄ becomes longer. On the other hand, if the set voltage is high (see the FIG. 6B), the number of pulses in each cycle becomes a large number of pulses N₃ (N₂<N₃). Accordingly, the oscillating portion A₅ becomes longer, and the oscillation-halted portion B₅ becomes shorter.

In this modified example, when the value of the voltage set by the controller 13 becomes a normal voltage, the number of pulses in the pulse signal in each cycle of intermittent oscillation becomes greater in accordance with this voltage, and the oscillating portion of the pulse signal becomes longer, while the oscillation-halted portion becomes shorter. Accordingly, the upper-limit value of the voltage that can be output to the load 12 becomes higher. Even if noise is generated due to the intermittent oscillation, and the frequency of this intermittent oscillation is within the audible frequency band, with respect to the frequency components of the noise, the frequency components of the pulse signal itself become relatively more numerous than the frequency components of intermittent oscillation. Because of this, if the frequency of the pulse signal is outside the audible frequency band, the noise can be made less perceptible to users.

Note that the present invention is in no way limited to the configurations of the preferred embodiments and modified examples described above, but rather various modifications are possible according to the purpose of its use and other factors. For example, in the process of controlling the oscillation of the oscillation circuit 73 (see FIG. 5), the oscillation control circuit 74 may increase or decrease the number of additional pulses randomly within a specified range.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. A switching power supply circuit comprising:
a transformer including a primary winding that is fed power from a power source and a secondary winding;
a switching element that switches the power fed to the primary winding and induces a voltage in the secondary winding;
an oscillator that oscillates to generate a pulse signal in order to control switching action of the switching element; and
a controller arranged and programmed to control the oscillator such that the oscillator repeatedly performs a plurality of intermittent oscillation cycles each including the oscillation to generate a pulse signal and halt of the oscillation, and in each of the intermittent oscillation cycles, increases or decreases a number of pulses in the pulse signal to lengthen or shorten an oscillating portion of the pulse signal, and when the oscillating portion is lengthened, an oscillation-halted portion of the pulse signal is made longer, whereas when the oscillating portion is shortened, the oscillation-halted portion is made shorter, so as to vary a period of the intermittent oscillation cycles.

3. The switching power supply circuit according to claim 2, further comprising:
an output device that smoothes the voltage induced in the secondary winding and outputs smoothed voltage to a load; and
the controller causes the oscillator to vary the period of the intermittent oscillation when the voltage to be output to the load by the output device is less than a threshold value, but when the voltage to be output is greater than or equal to the threshold value, the controller causes the oscillator to make the period of the intermittent oscillation constant, thus setting the number of pulses in the pulse signal in each cycle of the intermittent oscillation to a number of pulses that depends on the voltage to be output, without increasing or decreasing the number of pulses in the pulse signal in each cycle of the intermittent oscillation.
